(19) United States
(12) Patent Application Publication
(10) Pub. No.: US 2026/0035123 A1
(43) Pub. Date: Feb. 5, 2026

(54) PHARMACEUTICAL ORDER PROCESSING SYSTEMS

(71) Applicant: Express Scripts Strategic Development, Inc., St. Louis, MO (US)

(72) Inventors: Scott Swindells, Chesterfield, MO (US); Kenneth Perano, Saint Charles, MO (US)

(21) Appl. No.: 18/791,539

(22) Filed: Aug. 1, 2024

(51) Int. Cl. B65C 9/42; B65C 9/02; B65C 9/40

(52) U.S. Cl. CPC B65C 9/42; B65C 9/02; B65C 2009/401; B65C 2009/408

(57) ABSTRACT

A container processing system for processing a container. The container processing system includes a conveyor that transports the container toward a set location. A container positioner positions the container in the set location. A first container sensor detects a height of the container when the container is in the set location. A second container sensor detects a length of the container when the container is in the set location. A third container sensor detects a width of the container when the container is in the set location.

### FIELD

The present disclosure generally relates to pharmaceutical order processing systems, and more particularly to pharmaceutical container processing systems for processing pharmaceutical containers.

### BACKGROUND

High volume pharmacies process and fulfill a large number of prescription orders per day. These pharmacies often rely on automated systems to process, fill, and pack one or more prescriptions together for delivery to a patient. These automated systems generally fit into one of two categories: (1) systems, such as high-volume fillers, that automatically fill pharmaceutical containers (e.g., auto-filled containers) with specific quantities of pharmaceuticals; and (2) systems, such as unit-of-use systems, that process unit-of-use products or containers. A unit-of-use container contains an entire prescription of a pharmaceutical and can therefore be sent to the patient without modifying the pharmaceutical(s) (e.g., the quantity, type, etc.) in the container and without product packaging modification (or with minimal product packaging modification) except for labeling with patient information. Unit-of-use products can include a full course of medicine to be taken by a patient, for example, an entire prescription (e.g., a thirty-day supply, a sixty-day supply, or a ninety-day supply). The unit-of-use products contain known quantities of medication in packages that are closed and sealed by, for example, the pharmaceutical manufacturer.

### SUMMARY

In one aspect, a container processing system for a container comprises a conveyor configured to transport the container toward a set location. A container positioner is configured to position the container in the set location. A first container sensor is arranged to detect a height of the container when the container is in the set location. A second container sensor is arranged to detect a length of the container when the container is in the set location. A third container sensor is arranged to detect a width of the container when the container is in the set location.

In another aspect, a method of processing a container comprises positioning the container in a set location; determining at least one dimension of the container when the container is in the set location; validating the container by comparing the at least one dimension of the container with at least one reference dimension; and removing the container from the set location after said validating.

Other objects and features of the present disclosure will be in part apparent and in part pointed out herein.

### BRIEF DESCRIPTION OF THE DRAWINGS

FIG. 1 is a plan view of a pharmaceutical order processing system according to one embodiment of the present disclosure;

FIG. 2 is a perspective of a pharmaceutical container processing system according to one embodiment of the present disclosure;

FIG. 3 is an enlarged perspective of the pharmaceutical container processing system, with an enclosure hidden from view to reveal interior details;

FIG. 4 is a perspective of a pharmaceutical container repository according to one embodiment of the present disclosure;

FIG. 5 is an enlarged, fragmentary perspective of a pickup station of the pharmaceutical container repository;

FIG. 6 is an enlarged, fragmentary plan view of the pickup station;

FIG. 7 is a schematic diagram of an example control system for the pharmaceutical container processing system;

FIG. 8 is a flow chart of a training mode of the pharmaceutical order processing system; and

FIG. 9 is a flow chart of an operation mode of the pharmaceutical order processing system.

Corresponding reference characters indicate corresponding parts throughout the drawings.

### DETAILED DESCRIPTION

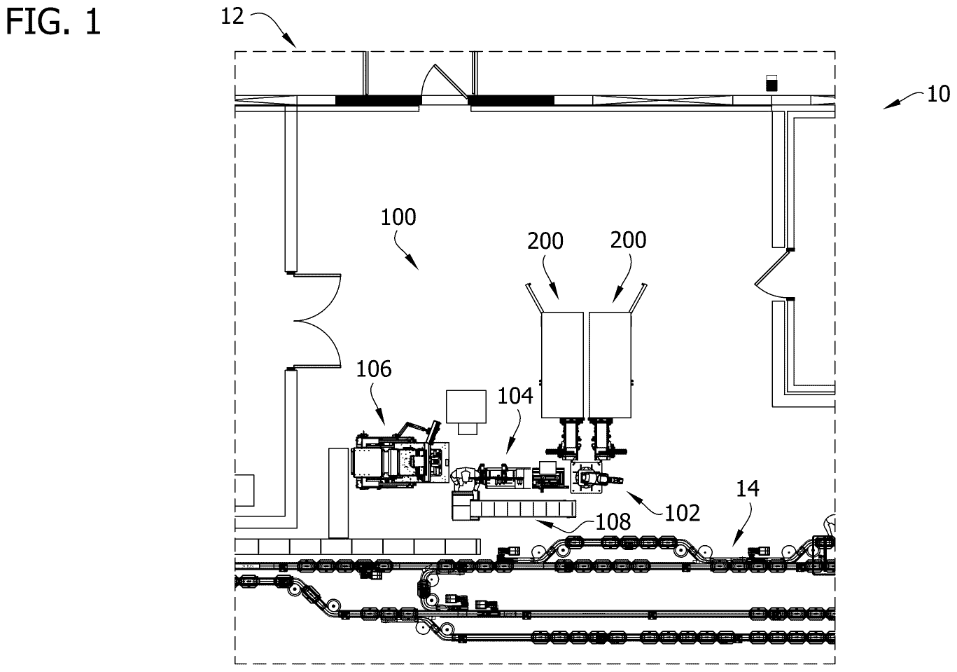

Referring to FIG. 1, a pharmaceutical order processing system according to one embodiment of the present disclosure is indicated generally by reference numeral 10. The pharmaceutical order processing system 10 is contained within a pharmacy 12 (e.g., a generally automated pharmacy). The pharmaceutical order processing system 10 processes prescription orders received by the system. A prescription order may include one or more pharmaceuticals (e.g., prescription drugs, over the counter medication, medical tests, or other medical articles), which are contained in pharmaceutical containers C. The pharmaceutical containers C may be in the form of a bottle, a box, a package, a cylinder, flat sided container, or any other suitable container. In this embodiment, the pharmaceutical order processing system 10 is a mix system comprising both unit-of-use container systems that process pharmaceutical containers C that are generally unit-of-use products and high-volume pharmaceutical order processing system (e.g., a high-volume filler) that fills empty pharmaceutical containers C with specific quantities of pharmaceuticals. In the illustrated embodiment, the pharmaceutical order processing system 10 includes a pharmaceutical container processing system 100 (described in more detail below) for processing unit-of-use products, a high-volume filler (not shown), and corresponding conveyors 14 (e.g., conveyor belts or tracks) for conveying or moving items (e.g., pharmaceutical containers, packages, bins) about the pharmaceutical order processing system. For example, the conveyors 14 can transport bins carrying pharmaceutical containers C processed (e.g., filled) by the high-volume filler to the pharmaceutical container processing system 100 to receive or marry up with pharmaceutical containers processed by the pharmaceutical container processing system that are part of the same prescription order, before being shipped to the patient. Further details on pharmaceutical order processing systems and components thereof, including unit-of-use systems and high-volume fillers, may be found in U.S. Pat. Nos. 9,373,065, 9,697,335, 9,944,419, 9,978,036, and 10,053,248, the entities of which are hereby incorporated by reference. However, it will be appreciated that the systems and components disclosed herein can be used in other contexts without departing from the scope of the present disclosure. For example, while embodiments described herein relate to pharmaceutical containers C, the systems and methods of the present disclosure can any container.

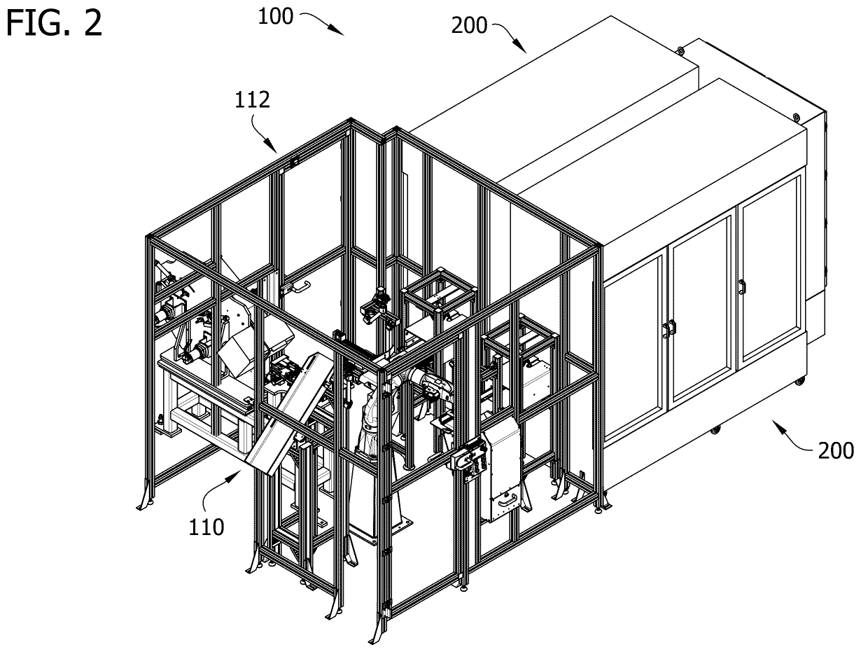

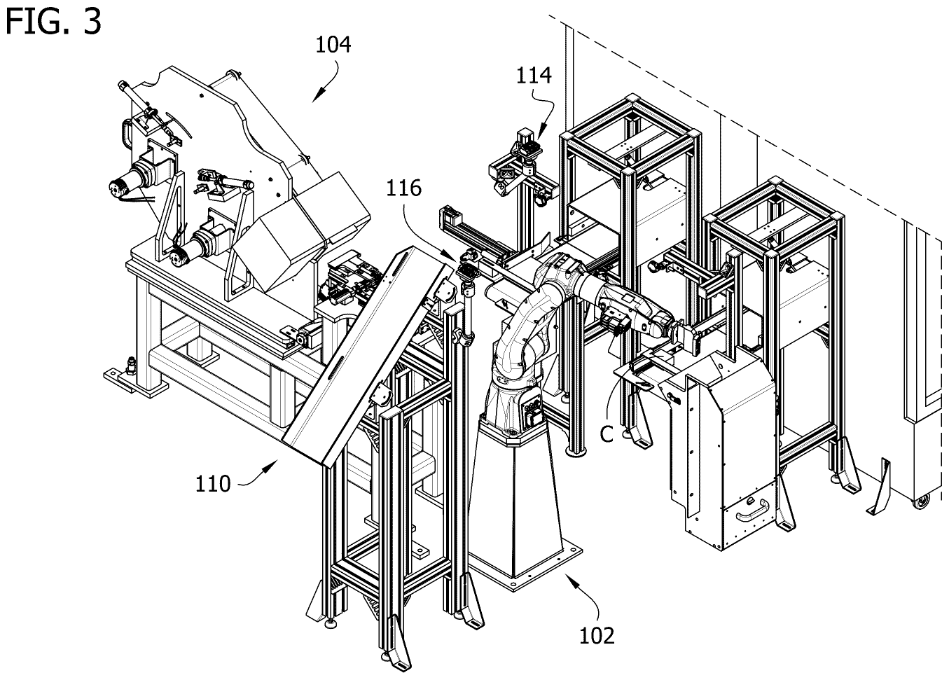

Referring to FIGS. 2 and 3, a pharmaceutical container processor or processing system (broadly, container processor or processing system) according to one embodiment of the present disclosure is indicated generally by reference numeral 100. The pharmaceutical container processing system 100 may be the pharmaceutical container processing system that is part of the pharmaceutical order processing system 10 of FIG. 1, or may be a standalone system. The pharmaceutical container processing system 100 processes prescription orders received by the system 10. Specifically, the pharmaceutical container processing system 100 may process a select category or subset of prescription orders received by the pharmaceutical order processing system 10, such as prescription orders comprising unit-of-use products. Accordingly, the pharmaceutical container processing system 100 comprises a unit-of-use system that processes pharmaceutical containers C that are unit-of-use products. The pharmaceutical container processing system 100 generally stores, labels, dispenses and packages the unit-of-use pharmaceutical containers C. The pharmaceutical container processing system 100 (e.g., system) processes the pharmaceutical containers C (e.g., a plurality of pharmaceutical containers) to fill prescription orders by storing, monitoring, labeling, dispensing, transporting, verifying and/or packaging the pharmaceutical containers to fill a prescription order received by the order processing system 10.

Referring to FIGS. 1-3, the system 100 includes at least one (e.g., two) container repositories 200, a container transporter 102, a labeler 104, a packaging device 106 such as a bagger, a conveyor 108, a ramp or chute 110, a first scanner or camera 114, and/or a second scanner or camera 116. Each container repository 200 is configured to hold and store pharmaceutical containers C. The two illustrated container repositories 200 are generally identical and placed back-to-back relative to one another. The container transporter 102 is configured to grab the container C from the container repositories 200 (e.g., from the pickup location 284 described below). In the illustrated embodiment, the container transporter 102 comprises a robot such as a six-axis robotic arm, although other robots are within the scope of the present disclosure. For example, the container transporter 102 may comprise a selective-compliance-articulated robotic arm, a cylindrical robot, a delta robot, a polar coordinate robot, a vertically articulated robot, a Cartesian coordinate robot or any other suitable device. In general, after picking up the pharmaceutical container C, the container transporter 102 transports the pharmaceutical container to the labeler 104. The labeler 104 is configured to generate and supply a label (e.g., a patient specific label) for the pharmaceutical container C. In one embodiment, the labeler 104 may print and then present the label so that the container transporter 102 can bring the pharmaceutical container C into contact with the label. The label may include a pressure sensitive adhesive, which as a result of coming into contact with the pharmaceutical container C, causes the label to stick to the pharmaceutical container. After the label is applied to the pharmaceutical container C, the container transporter 102 either drops the pharmaceutical container on the conveyer 108 or on the chute 110 (broadly, a drop-off location).

Before applying the patient label to the pharmaceutical container C, the container transporter 102 may transport the pharmaceutical container to a first scanning location (broadly, to the first scanner 114). The first scanner 114 is arranged to scan a machine-readable marking or code, such as a barcode or QR code (although other types of codes may be used without departing from the scope of the present disclosure), of the pharmaceutical container C when the pharmaceutical container is at the first scanning location. This allows the system 100 to validate or confirm that the correct type of pharmaceutical container was dispensed (such as by matching the dispensed pharmaceutical container to the type of pharmaceutical container called for by the prescription order). After applying the patient label to the pharmaceutical container C, the container transporter 102 may transport the pharmaceutical container to a second scanning location (broadly, to the second scanner 116). The second scanner 116 is arranged to scan a machine-readable marking or code, such as a barcode or QR code (although other types of codes may be used without departing from the scope of the present disclosure), of the label applied to the pharmaceutical container C when the pharmaceutical container is at the second scanning location. This allows the system 100 to validate or confirm that the correct label was placed on the pharmaceutical container C (such as by matching the patient name of the label to the name on the prescription order) and that the label was in fact applied to the pharmaceutical container. The first and second scanners 114, 116 may each be any suitable scanner, such as a camera or barcode scanner. Other types of scanners may be used without departing from the scope of the present disclosure.

If the container transporter 102 drops the pharmaceutical container C on the conveyor 108, the conveyor transports the pharmaceutical container to the packaging device 106 to package the pharmaceutical container C for shipping. In an example, an operator moves the pharmaceutical container C from the conveyor 108 to the packaging device 106. In an example, a robot may pick the container C from the conveyor 108 and place it in a shipping container, e.g., a bag, box or cooler, or the like. In other embodiments, the packaging device 106 may receive the pharmaceutical container C directly from the conveyor 108. The packaging device 106 (broadly, a shipping preparation device) can be any suitable device for bagging, packaging, sealing, boxing, etc., one or more containers C for shipping the containers to the patient. For example, the packaging device 106 may be a pre-formed bag bagger, a wrap seal bagger, or any other suitable device. The packaging device 106 is configured to package or bag one or more pharmaceutical containers C in a package (e.g., bag). The packaging device 106 generally prepares the container C for shipping to the patient. This may include adding corresponding literature regarding the prescription order for packaging with the pharmaceutical container C. The literature may be in the form of a slip, sheet, pamphlet, book, and the like and may contain information (e.g., directions) related to the pharmaceuticals in the pharmaceutical container and/or other information (e.g., patient information) related to the prescription order. When packing the pharmaceutical containers C, the packaging device 106 can also pack the corresponding literature (e.g., a literature pack) for the pharmaceutical containers C in the shipping package. After, the package is shipped to the patient.

The chute 110 leads to the conveyors 14 of the order processing system 10. If the container transporter 102 drops the pharmaceutical container C on the chute 110, the chute guides and delivers the container to the conveyor 14. For example, the dropped pharmaceutical container C may slide down the chute 110 and into a bin (not shown) on the conveyor 14, which may or may not include containers from other parts of the pharmacy 10. The conveyor 14 can then transport the bin to other locations in the pharmacy 10 for further processing.

The system 10 includes an enclosure 112 (hidden from view in FIG. 3). The enclosure 12 defines (e.g., encloses) a processing area. In general, a portion of the container repositories 200, the container transporter 102, a portion of the labeler 104, a portion of the conveyor 108, and a portion of the chute 110 are disposed in the processing area. The enclosure 112 helps keep the processing area and components therein clean.

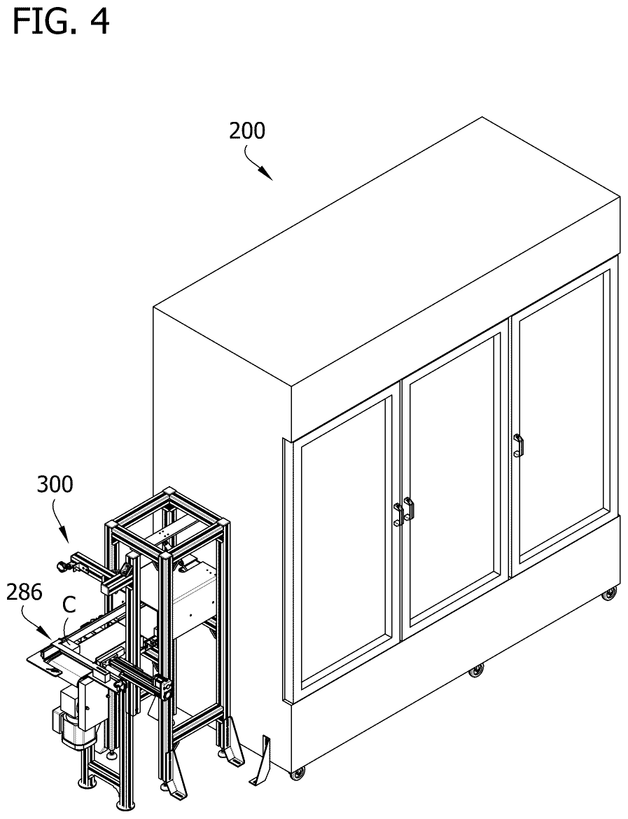

Referring to FIGS. 3-6, the container repository 200 is configured to hold and store a supply of pharmaceutical containers C. The container repository 200 receives and holds the pharmaceutical containers C and can hold many different types of pharmaceutical containers (e.g., types of pharmaceuticals). The container repository 200 can be configured to hold pharmaceutical containers C of different shapes and of generally any size. For example, the container repository 200 can be configured for boxes of generally any shape and size. In one embodiment, the pharmaceutical containers C are manually loaded into the container repository 200 by an operator. The container repository 200 dispenses one or more pharmaceutical containers C, as needed, to fill the prescription orders (fill an entire order to a portion of an order) received by the pharmaceutical order processing system 10. The container repository 200 stores and holds the pharmaceutical containers C according to type in individual lanes or stacks. That is all the pharmaceutical containers C in one lane are of the same type (e.g., are identical).

To dispense the pharmaceutical containers C, the container repository 200 includes a container transporter 214. The container transporter 214 is configured to transport the pharmaceutical containers C toward (e.g., to) a set or pick-up location 284 of the container repository, after the containers are removed from their respective lanes. In the illustrated embodiment, the container transporter 214 comprises a conveyor (e.g., an endless conveyor belt), although other types of container transporters can be used without departing from the scope of the present disclosure. Further details on the dispensing and transporting operation and components of the container repository 200 are described in U.S. application Ser. No. 18/442,259, filed Feb. 15, 2024, the entirety of which is hereby incorporated by reference.

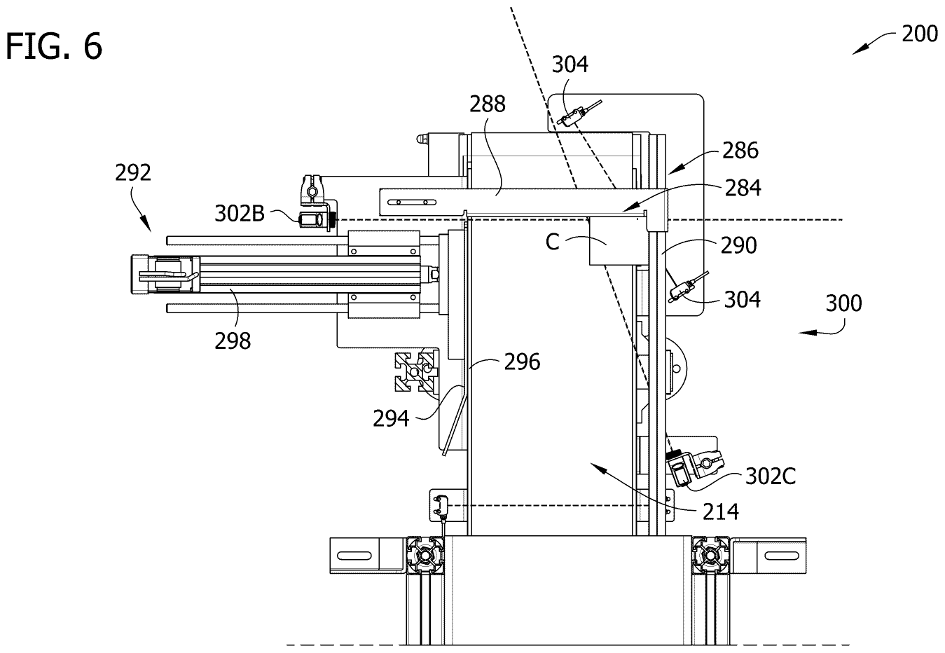

The container transporter 214 (e.g., conveyor) is configured to transport the pharmaceutical containers C toward the pickup location 284 (FIG. 6). The container transporter 102 is configured to remove the pharmaceutical container C from the pickup location. Having a pickup location prevents the container transporter 102 (or some other device) from having to determine the location of the pharmaceutical container C about to be picked up. The container repository 200 includes a container locator 286 defining the pickup location. The container locator 286 forms a corner or pocket. When the pharmaceutical container C (e.g., a corner thereof) is in the corner of the container locator 286, then the pharmaceutical container is in the pickup location 284. In the illustrated embodiment, the container locator 286 includes a cross-rail 288 (broadly, a first guide) and a side rail 290 (broadly, a second guide). The cross-rail 288 extends across the conveyor belt and prevents the pharmaceutical container C from continuing to move with the conveyor belt. The side rail 290 extends along one side of the conveyor belt. The cross-rail 288 is oriented generally perpendicularly to the side rail 290. Together the cross-rail 288 and the side rail 290 form the corner of the container locator 286. The container transporter 214 supports the pharmaceutical containers C in the pickup location. Specifically, the pharmaceutical containers C rest on the conveyor belt in the pickup location (the conveyor belt may slide under the containers in the pickup location).

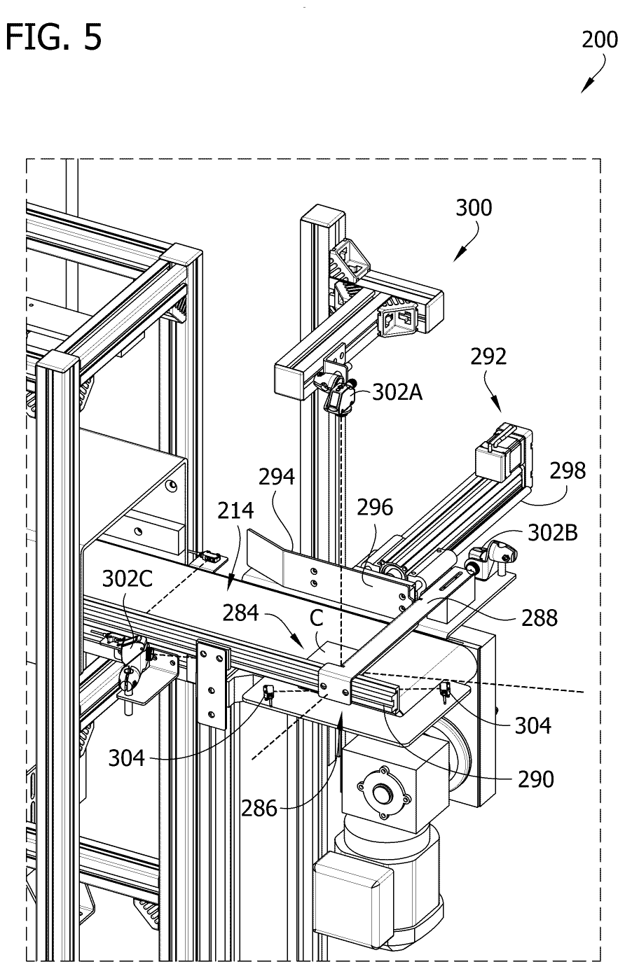

It is appreciated that the manner in which the pharmaceutical containers Care moved to the container transporter 214 results in the pharmaceutical containers being in a position suitable for nesting with the corner of the container locator 286 (e.g., the length and width of the pharmaceutical container are generally parallel to the width and length, respectively, of the conveyor belt). However, the pharmaceutical containers C may generally be at any position, widthwise, on the conveyor belt. Accordingly, the container repository 200 may include a container positioner 292 configured to position the pharmaceutical containers C in the pickup location 284. In the illustrated embodiment, the container positioner 292 is a pusher arranged to push the pharmaceutical containers C against the side rail 290. Thus, the combined operation of the conveyor moving the pharmaceutical containers C toward and against the cross-rail 288 and the container positioner 292 moving the pharmaceutical containers toward and against the side rail 290 moves the pharmaceutical containers into the corner of the container locator 286, and therefore into the pickup location 284. The container positioner 292 will generally move (e.g., engage) pharmaceutical containers C one at a time. In the illustrated embodiment, the container positioner 292 includes a push plate 294 defining a push surface 296 for pushing the pharmaceutical containers C against the side rail 290. The push plate 294 is operatively connected to a prime mover 298 (e.g., positioner prime mover) of the container positioner 292. In the illustrated embodiment, the prime mover 298 is a pneumatic linear actuator, although other types of prime movers (e.g., electric linear actuator, electric motor, etc.) may be used without departing from the scope of the present disclosure. In operation, the positioner prime mover 298 extends the push plate 294 from a home position (FIGS. 5 and 6) toward the side rail 290 to push the pharmaceutical container C against the side rail and then retracts the push plate 294 back to the home position. This may occur before or after the pharmaceutical container C contacts the cross-rail 288.

Referring to FIGS. 5 and 6, the container repository 200 includes a sensor array 300 configured to determine or detect the height, width, and/or length (broadly, at least one dimension) of the pharmaceutical containers C when the pharmaceutical containers are in the pickup location 284. The sensor array 300 includes at least one container sensor 302 (e.g., container dimension sensor) arranged to detect the height, width, or length of the pharmaceutical containers C when the pharmaceutical containers are in the pickup location 284. The sensor array 300 includes a first or height container sensor 302A arranged to detect the height of the pharmaceutical container C in the pickup location 284. The height container sensor 302A overlies the pickup location 284 and faces downward toward the pickup location. The sensor array 300 includes a second or length container sensor 302B arranged to detect the length of the pharmaceutical container C in the pickup location 284. As a reference, the length of the pharmaceutical containers C is oriented generally perpendicularly to the travel direction of the container transporter 214 (likewise the width of the pharmaceutical container is oriented generally parallel to the travel direction). The length container sensor 302B is disposed just upstream of the cross-rail 288. The sensor array 300 includes a third or width container sensor 302C arranged to detect the width of the pharmaceutical container C in the pickup location 284. The width container sensor 302C is offset (e.g., laterally or horizontally offset) from the container transporter 214 and is oriented at (e.g., a sensor beam thereof is oriented at) an a known or set angle to the travel direction of the container transporter (e.g., oriented at an angle to the width of the pharmaceutical container). This configuration allows the pharmaceutical container C to move toward the pickup location 284 without being blocked by the width container sensor 302C. Using basic trigonometry using the known angle of orientation of the width container sensor 302C and the distance measured by the width container sensor, the width of the pharmaceutical container C can be determined. The length container sensor 302B is disposed just upstream of the pickup location 284 and is arranged to face the pickup location (through a gap or opening in the side rail 290). In one embodiment, the container sensors 302 are laser sensors suitable for measuring a distance, although other types of sensors may be used without departing from the scope of the present disclosure.

The sensor array 300 may also include a container position sensor 304 arranged to detect whether or not the pharmaceutical container C is in the pickup location 284. In the illustrated embodiment, the container position sensor 304 comprises beam-break sensors arranged such that a beam (e.g., light beam) extends through the pickup location 284 at the corner formed by the container locator 286 (e.g., as close to the corner as possible). When the corner of the pharmaceutical container C is nested with the corner of the container locator 286, the corner of the pharmaceutical container breaks or interrupts the beam, thereby indicating that the pharmaceutical container is in the pickup location. The beam may extend through gaps or openings in the cross-rail 288 and/or side rail 290. Other types of sensors may be used without departing from the scope of the present disclosure.

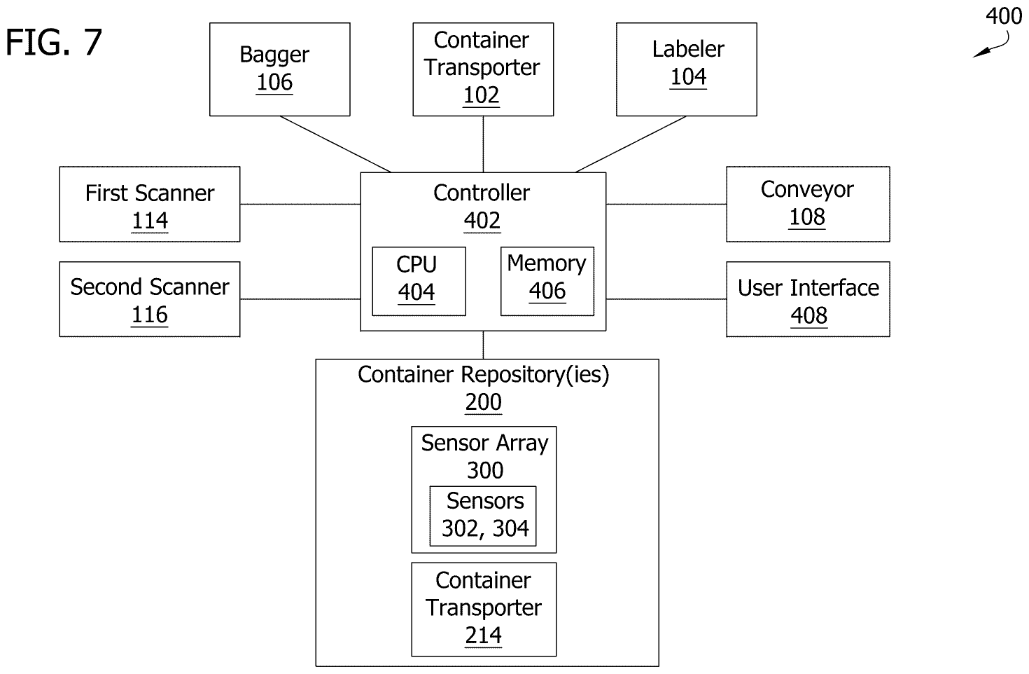

Referring to FIG. 7, an example control system (e.g. pharmaceutical container processing system control system) of the pharmaceutical container processing system 100 is generally indicated by reference numeral 400. The control system 400 includes a controller 402 (broadly, a computer) for controlling and operating the pharmaceutical container processing system 100 and its components. The controller 402 includes a CPU or processor 404 (e.g., a pharmaceutical container processing system processor) and RAM or memory 406 (broadly, non-transitory computer readable storage medium). The controller 402 directs (e.g., controls and operates) the various components (e.g., the container repositories 200, the container transporter 102, the labeler 104, the packaging device 106, the conveyor 108, etc.) and sub-components (e.g., sensor array 300, etc.) thereof. Broadly, the memory 406 includes (e.g., stores) processor-executable instructions for controlling the operation of the pharmaceutical container processing system 100 and the components thereof. The instructions embody one or more functional aspects of the pharmaceutical container processing system 100 and components thereof (as described herein), with the processor 402 executing the instructions to perform said one or more functional aspects. The components of the pharmaceutical container processing system 100 may be in wired or wireless communication with the controller 402. The controller 402 may be a dedicated controller for the pharmaceutical container processing system 100 (as illustrated) that is in communication with a control system of the pharmacy 12 or part of the control system of the pharmacy. Other configurations of the control system 400 may be used without departing from the scope of the present disclosure.

The control system 400 may include a user interface 408, such a laptop, personal computer, smart phone, tablet, keyboard, screen, touch screen, mouse, etc., for allowing the user to interact with the pharmaceutical container processing system 100.

The controller 402 is communicatively coupled to the various components of the pharmaceutical container processing system 100 to control and/or operate these components. The controller 402 is configured to receive a prescription order for a patient and to direct (e.g., operate), as described herein, the pharmaceutical container processing system 100 to fulfill the prescription order (e.g., prepare a package for shipping containing the one or more pharmaceutical containers C that the prescription order calls for). For example, the controller 402 can operate the container repository 200 to dispense the appropriate pharmaceutical container C (based on the received prescription order) to the pickup location 284. The controller 402 can then operate the container transporter 102 to remove the dispensed pharmaceutical container C from the pickup location 284. The controller 402 may also provide information (e.g., patient name, prescription information, etc.) to the labeler 104 for the creation of the label for the pharmaceutical container C. Other types of information can also be shared between the controller 402 and the components of the pharmaceutical container processing system 100. Accordingly, it is understood the controller 402 directs the components of the pharmaceutical container processing system 100 as necessary to perform the functions described herein.

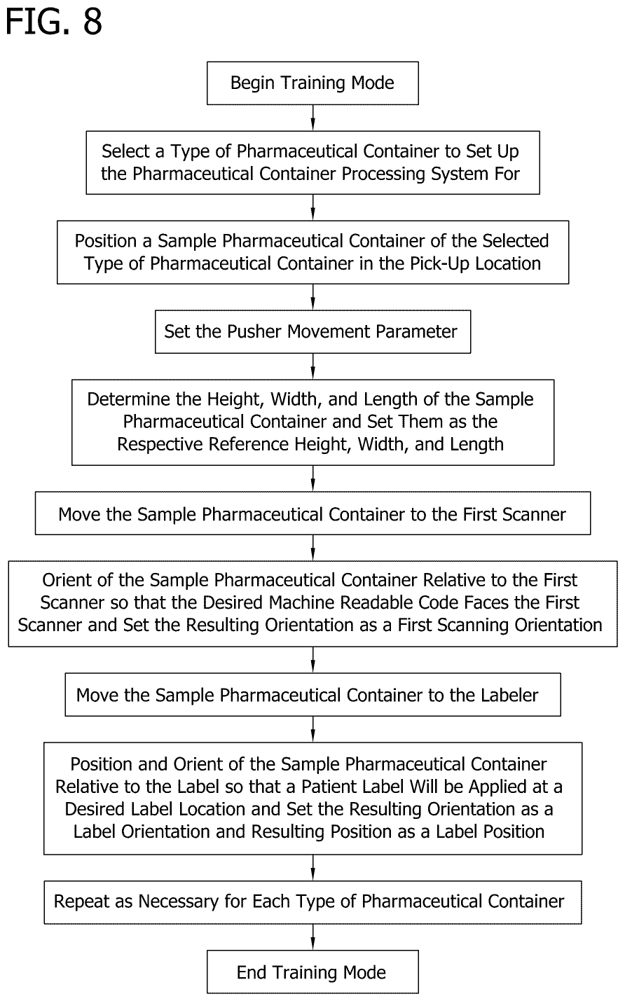

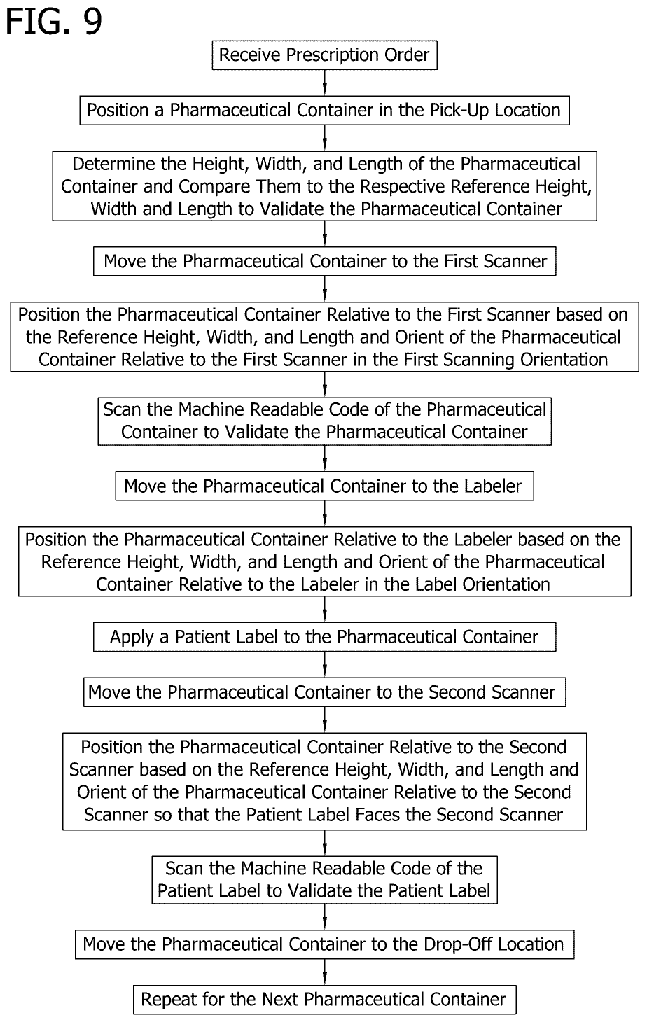

The pharmaceutical container processing system 100 can be placed in a training or set-up mode (FIG. 8) and an operation or processing mode (FIG. 9). In the training mode, an operator configures or sets-up the system 100 for use with the various types of pharmaceutical containers C held in the container repositories 200 that will be processed by determining various set-up parameters. In the operation mode, the system 100 processes the pharmaceutical containers C held in the container repositories in order to fill prescription orders. During the operation mode, the system 100 uses set-up parameters obtained during the training mode when processing the pharmaceutical containers C.

Referring to FIG. 8, the operator enters the training mode via the user interface 408 to configure the pharmaceutical container processing system 100. First, the operator selects the type of pharmaceutical container C. In one example, the operator selects the type of pharmaceutical container C by selecting a particular lane of the container repository 200. After selecting the type of particular pharmaceutical container C, the container repository 200 dispenses one such pharmaceutical container of the type selected, herein referred to as a sample or test pharmaceutical container. The sample pharmaceutical container C is then positioned in the pick-up location 284. The container transporter 214 transports the sample pharmaceutical container toward the pick-up location 284 and then the container positioner 292 pushes the sample pharmaceutical container into the pick-up location. Because the size (e.g., length) of the sample pharmaceutical container C is not yet known, the prime mover 298 may gradually move the push plate 294 until the container position sensor 304 detects that the sample pharmaceutical container is in the pick-up location 284. For example, the prime mover 298 may gradually move by discrete increments (e.g. ¼ inch). The control system 400 may store or set (in a database) a pusher movement parameter (broadly, a set-up parameter) corresponding to the position of the push plate 294 when the sample pharmaceutical container C was detected as being in the pick-up location 284. The saved pusher movement parameter is associated with the type of pharmaceutical container C the sample pharmaceutical container is, for use during the operation mode. The pusher movement parameter may correspond to a distance or length of time the prime mover 298 was operated or the position of the prime mover when the sample pharmaceutical container was detected in the pick-up location.

With the sample pharmaceutical container C in the pick-up location, the system 100 determines at least one dimension (broadly, at least one-dimensional parameter) of the sample pharmaceutical container C. The at least one dimension of the sample pharmaceutical container C is then set as at least one reference dimension (broadly, at least one reference parameter) for use during the operation mode. Specifically, the system 100 determines a height of the sample pharmaceutical container C with the height container sensor 302A, a length of the sample pharmaceutical container with the length container sensor 302B, and/or a width of the sample pharmaceutical container with the width container sensor 302C. The control system 400 may store (in the database) the determined height, length, and width of the sample pharmaceutical container. The control system 400 sets the determined height of the sample pharmaceutical container C as a reference height, the determined width of the sample pharmaceutical container as a reference width, and the determined length of the sample pharmaceutical container as a reference width. The operator may accept or not accept the determined reference dimensions via the user interface 408. Based on these reference dimensions (broadly, set-up parameters), the container transporter 102 picks up the sample pharmaceutical container C, desirably at the center of the upward facing face of the sample pharmaceutical container. The container transporter 102 includes end-of-arm tooling, such as a suction head, that allows the container transport to pick up the sample pharmaceutical container C. Using the reference dimensions (e.g., reference height, width, and length), the container transporter 102 is able to position and pick up the sample pharmaceutical container C with the end-of-arm tooling from the center of the upward facing face when the sample pharmaceutical container is in the pick-up location 284.

After picking up the sample pharmaceutical container C, the container transporter 102 moves the sample pharmaceutical container toward the first scanner 114. In most situations, the type of pharmaceutical container C that the sample pharmaceutical container is will have many different machine-readable codes across various faces of the pharmaceutical container. During the training mode, the operator selects which face of the pharmaceutical container C will be presented during the operation mode. To do this, the sample pharmaceutical container C is oriented relative to the first scanner 114 until the desired machine-readable code of the sample pharmaceutical container is facing the first scanner. The desired machine-readable code is the one that, when read, can be used to validate that the correct type of pharmaceutical container was dispensed. For example, the machine-readable code may represent a product serial number, which can then be compared to the product serial number required by the prescription order, to ensure they match.

In one embodiment for selecting the correct face, the container transporter 102 presents a first face of the sample pharmaceutical container C to the first scanner 114. The container transporter 102 arranges the pharmaceutical container C relative to the first scanner 114 based on the dimensional parameters (e.g., based on the reference dimensions) determined earlier. Desirably, based on the dimensional parameters, the container transporter 102 arranges or positions the first face so that it is generally in the center of the field of view of the first scanner 114 and the first face is at an optimal distance from the first scanner 114. For example, the optimal distance may be about 12 inches. If the first face is too close or too far from the first scanner 114 (and the second scanner 116), the first scanner (and second scanner) may not be able to read any machine-readable codes on the first face. The first scanner 114 then scans the first face. The scan of the first face is presented to the operator, via the user interface 408. The control system 400 may identify any machine-readable codes on the scan of the first face and ask the operator if any of the identified machine-readable codes are the desired code. If yes, the operator indicates as much via the user interface 408. The control system 400 saves or sets the orientation that the sample pharmaceutical container C is in relative to the first scanner 114 (when the desired machine-readable code of the sample container is facing the first scanner) as a first scanning orientation (broadly, first scanning parameter), to be used during the operation mode. The control system 400 may also save the face (e.g., first face) the desired machine-readable code was found on. The control system 400 may also save the coordinates or location (e.g., x and y coordinates) in the scan of the first face where the desired machine-readable code is located. This is particularly useful if the first face continues more than one machine readable code at it allows the system 400 to identify the correct machine-readable code to scan. The control system 400 may also save the type of code (e.g., barcode, QR code, etc.) of the desired machine-readable code. The control system 400 may also save what orientation the machine-readable code is in relative to the first scanner 114. If the operator indicates the desired machine-readable code is not on the first face, then the process repeats with the next face. The container transporter 102 reorients the sample pharmaceutical container C to present the next (e.g., second) face, and so on, until the correct face with the desired machine readable code has been presented to the first scanner 114 and the first scanning parameters (e.g., first scanning orientation, face number, coordinates of machine readable code, type of code, orientation of code) (broadly, set-up parameters) have been set. Other ways of selecting the face to present to the first scanner may be used without departing from the scope of the present disclosure.

After scanning by the first scanner 114, the container transporter 102 moves the sample pharmaceutical container toward the labeler 104. During the training mode, the operator selects where the patient label from the labeler 104 will be applied to the pharmaceutical container C (e.g., selects the label location) during the operation mode. To do this, the sample pharmaceutical container C is arranged (e.g., oriented and/or positioned) relative to the labeler 104 until the patient label from the labeler will be applied at the desired label location on the sample pharmaceutical container. As mentioned above, in the illustrated embodiment, the patient label is applied to the pharmaceutical container C by the container transporter 102 moving the pharmaceutical container into contact with the patient label (exposed adhesive thereof), although other ways of applying the patient label may be used without departing from the scope of the present disclosure.

In one embodiment, the patient label is applied to the bottom face of the pharmaceutical container C (e.g., the face opposite the face the container transporter 102 is gripping to hold the pharmaceutical container), although it is understood the patient label can be applied to any face of the pharmaceutical container. In one embodiment, the operator selects the face that the patient label will be applied to via the user interface 408. The face of the pharmaceutical container C that the patient label will be applied to is herein called the label face. In one embodiment, the labeler 104 is able to apply a first or larger size of patient label and a second or smaller size (compared to the first size) of patient label. Based on the dimensional parameters determined earlier, the control system 400 determines if the label face is large enough to receive the larger size of patient label. If yes, the labeler 104 provides the larger size of patient label. If no, the labeler 104 provides the smaller size of patient label. The operator may accept or not accept the label size via the user interface 408. The determined size of the patient label can be set or stored as a label size parameter (broadly, a set-up parameter).

The operator can also arrange the sample pharmaceutical container C relative to the labeler so that the label will be applied at the desired label location. The operator can change and set the orientation of the label face (broadly, the sample pharmaceutical container C) relative to the patient label. For example, it may be desirable that the patient label be oriented in the same direction as any images and/or text on the label face (e.g., words on the patient label are oriented in the same manner as words on the label face when the patient label is applied to the label face). The operator may manually insert different orientations to try and/or the control system 400 may take the operator through various predetermined orientations. The operator can change and set coordinates (e.g., x and y coordinates) for the label location on the label face. In one example, these coordinates are in the form of offset dimensions from a center of the label face (the center of the label face being a default label location). Desirably, the label location is one in which the label will not cover up any important information, such as a pharmaceutical or drug name, a pharmaceutical or drug dosage, a pharmaceutical or drug amount, machine readable codes, etc. In some methods of operation, the operator may go through several rounds of trial and error before finding the arrangement of the sample pharmaceutical container C that results in the patient label being applied at the desired label location on the label face (broadly, pharmaceutical container). The operator may confirm correct label location via the user interface 408. The control system 400 saves or sets the orientation that the sample pharmaceutical container C is in relative to the labeler 104 (when the patient label will be applied at the desired label location) as a label orientation (broadly, a label orientation parameter, more broadly, a set-up parameter). Also, the control system 400 saves or sets the position (e.g., offsets) that the sample pharmaceutical container C is in relative to the labeler 104 (when the patient label will be applied at the desired label location) as a label position (broadly, a label position parameter, more broadly, a set-up parameter). The position of the label face relative to the labeler 104 when the patient label will be applied at the desired label location may be referred to as a label or label face position. The orientation of the label face relative to the labeler 104 when the patient label will be applied at the desired label location may be referred to as a label or label face orientation.

This training process is repeated as necessary to configure the system 100 for each type of pharmaceutical container C that can be dispensed and processed by the system. The control system 400 may associate the set-up parameters with a particular type of pharmaceutical container C and/or with a particular lane of the one or more container repositories 200. This way the control system 400 can recall the set-up parameters as needed during the processing of the pharmaceutical containers C during the operation mode. This manner of configuring the system 100 for different types of pharmaceutical containers C by running a sample pharmaceutical container makes it fast and easy to set up the system and does not require much technical skill on the part of the operator setting up the system.

Referring to FIG. 9, the operator may place the pharmaceutical container processing system 100 in the operation mode via the user interface 408. In the operation mode, the system 100 dispenses and processes the pharmaceutical containers C needed to fill the received prescription orders. The processing of one pharmaceutical container C will now be discussed with the understanding the process generally repeats for each pharmaceutical container from the system 100 that is used to fill the prescription orders. After receiving a prescription order, the system 100 moves a pharmaceutical container C toward the pick-up location 284 via the container transporter 214. The selected pharmaceutical container C is of a type that is required to fill the received prescription order. The pharmaceutical container C is positioned in the pick-up location 284, via the container transporter 214 and the container positioner 292. In particular, the control system 400 operates the prime mover 298 of the container positioner 292 based on the pusher movement parameter to move the pharmaceutical container C to the pick-up location 284. The container position sensor 304 detects when the pharmaceutical container C is in the pickup location 284.

With the pharmaceutical container C is in the pick-up location 284, at least one dimension of the pharmaceutical container C is determined. In particular, a height of the pharmaceutical container C is determined with the height container sensor 302A, a length of the pharmaceutical container is determined with the length container sensor 302B, and/or a width of the pharmaceutical container is determined with the width container sensor 302C. The system 100 (e.g., control system 400) then validates (e.g., a first validation) that the correct pharmaceutical container C was dispensed by the container repository 200 (e.g., the dispensed pharmaceutical container contains the pharmaceutical(s) needed to fill the received prescription order) by comparing the at least one dimension of the pharmaceutical container C with the at least one reference dimension. In particular, the detected height, width, and length of the pharmaceutical container C is compared to the respective reference height, reference width, and reference length associated with the type of pharmaceutical container C the dispensed pharmaceutical container belongs to. If the detected dimensions of pharmaceutical container C match or are within an acceptable variation (e.g., +5%) of the reference dimensions, then the system 100 has confirmed the correct pharmaceutical container C has been dispensed.

After the validation using the determined dimension of the pharmaceutical container C, the container transporter 102 removes the pharmaceutical container from the pick-up location 284. The container transporter 102 picks up the pharmaceutical container C, desirably at the center of the top face as explained above, based on the reference dimensions determined during the training operation. Using the reference dimensions, the container transporter 102 moves its end-of-arm tooling to the appropriate location to pick up the pharmaceutical container C.

After picking up the pharmaceutical container C from the pick-up location 284, the container transporter 102 moves the pharmaceutical container to the first scanning location to be scanned by the first scanner 114. To present the appropriate face (and machine-readable code thereon) to the first scanner 114 when in the first scanning location, the container transporter 102 orients the pharmaceutical container C relative to the first scanner 114 in the first scanning orientation. In addition, the container transporter 102 positions the pharmaceutical container C relative to the first scanner 114 in the first scanning location based on the at least one reference dimension. In particular, based on the reference height, width, and/or length, the container transporter 102 positions the pharmaceutical container C relative to the first scanner 114 to be scanned by the first scanner, like how the sample pharmaceutical container was positioned in the training mode. After the pharmaceutical container C is positioned and oriented in the first scanning location, the pharmaceutical container C is scanned by the first scanner 114. The first scanner 114 reads the machine-readable code on the presented face of the pharmaceutical container C to again validate (e.g., a second validation) the pharmaceutical container is of the correct type. If needed, the control system 400 uses the coordinates of the machine-readable code, the type of code, and/or the orientation of the machine-readable code to identify and/or read the correct code on the presented face.

If the first scanner 114 or the system cannot recognize the container C by its machine-readable code or the machine-readable code is not recognizable, the container transport can manipulate the container C to present a different face of the container C to the first scanner 114. This can be repeated until the container is identified and validated. If container C is not validated, it is rejected and placed into a rejection receptacle by the container transporter 102.

After the pharmaceutical container C is validated by the first scanner 114, the container transporter 102 moves the pharmaceutical container to the labeler 104. The labeler 104 creates the patient label. The size of the created patient label is determined by the label size parameter. The container transporter 102 orients the pharmaceutical container C relative to the patient label (broadly, labeler 104) in the label orientation. The container transporter 102 also positions the pharmaceutical container C relative to the patient label based on the at least one reference dimension. In particular, based on the reference height, width, and/or length, the container transporter 102 positions the pharmaceutical container C relative to the label in order to have the label applied in the label location on the label face. If needed, the position of the pharmaceutical container C relative to the container transporter 102 is further based on the label position parameter, to account for the inserted offset from the training mode. After the pharmaceutical container C is arranged (e.g., positioned and/or oriented) relative to the patient label, the patient label is applied to the pharmaceutical container, as described herein.

After the patient label is applied to the pharmaceutical container C, the container transporter 102 moves the pharmaceutical container to the second scanning location so that the applied patient label can be scanned by the second scanner 116. The container transporter 102 presents the applied patient label to the second scanner 116. The control system 400 positions the pharmaceutical container C relative to the second scanner 116 based on the at least one reference dimension. In particular, based on the reference height, width, and/or length, the container transporter 102 positions the pharmaceutical container C relative to the second scanner 116 so that the patient label can be scanned by the second scanner. This positioning may also be based on the label location. For example, based on the reference dimensions, the container transporter 102 arranges or positions the label face so that it is generally in the center of the field of view of the second scanner 116 and the label face is at an optimal distance from the second scanner 116. Further, if the label face includes other machine-readable codes, the control system 400 can use the label location (e.g., x and y coordinates for the label face) to identify and read the machine-readable code of the patient label. After the pharmaceutical container C is located in the second scanning location, the applied patient label is scanned by the second scanner 116. The second scanner 116 reads the machine-readable code on the patient label to validate (e.g., a third validation) the correct patient label was applied to the pharmaceutical container C (such as by matching patient and/or pharmaceutical information associated with the machine-readable code with the corresponding information in the prescription order). Scanning the patient label also ensures that the label was properly applied to the pharmaceutical container C.

After the patient label on the pharmaceutical container C is validated by the second scanner 116, the container transporter 102 moves the pharmaceutical container to the drop-off location (e.g., chute 110 or conveyor 108). The container transporter 102 may position the pharmaceutical container C at the drop-off location based on the at least one reference dimension. For example, based on the reference height, width, and/or length, the container transporter 102 may position the pharmaceutical container C at the drop-off location in a manner that minimizes or eliminates any distance the pharmaceutical container may fall when released by the container transporter. In an example, the based on the reference width and length, the container transporter 102 can position generally the entire pharmaceutical container C over the chute 110 or conveyor 108 and, based on the reference height, place the pharmaceutical container on the chute or conveyor. The container transporter 102 may also use the reference height, width, and/or length to orient the pharmaceutical container C in the drop-off location (e.g., orient the pharmaceutical container generally horizontally for the conveyor 108 or at an angle to the horizontal matching the angle of the chute 110 for the chute). After the pharmaceutical container C is released in the drop-off location, the process repeats for the next pharmaceutical container C to be processed by the system 100.

It is understood that the various operations in the operation mode can occur simultaneously for different pharmaceutical containers. For example, the conveyor transporter 214 can be transporting one pharmaceutical container C toward the pick-up location 284 while the container transporter 102 is moving another pharmaceutical container along the first scanner, 114, the labeler 104, the second scanner 116, and/or to the drop-off location.

If, at any point, one of the validation steps is failed, an error or other type of message can be displayed to the operator, via the user interface 408. In this case, the operator can manually remove the pharmaceutical container C and/or tell the container transporter 102 to move and drop the pharmaceutical container C at a discharge location.

The two illustrated container repositories 200 are each generally identical. Accordingly, the training and operation of one container repository 200 in the system 100 as described herein applies to each container repository.

Other ways of processing the pharmaceutical containers C may be used without departing from the scope of the present disclosure. For example, instead of using the reference dimensions to position the pharmaceutical container C relative to the first scanner 114, labeler 104, second scanner 116, and/or drop-off location and/or to pick up the pharmaceutical container with the container transporter from the pick-up location 284, the system 100 may use the determined dimensions from the sensor array 300 (detected during the operation mode).

Although described in connection with an example computing system environment, embodiments of the aspects of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the example operating environment. Examples of well-known computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the disclosure.

Embodiments of the aspects of the disclosure may be implemented with processor-executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

It is apparent that the elements, features, and/or teachings set forth in each embodiment disclosed herein are not limited to the specific embodiment(s) the elements, features and/or teachings are described in. Accordingly, it is understood that the elements, features and/or teachings described in one embodiment may be applied to one or more of the other embodiments disclosed herein, even if said elements, features and/or teachings where not described herein as being a part of said one or more of the other embodiments.

The Title, Field, and Background are provided to help the reader quickly ascertain the nature of the technical disclosure. They are submitted with the understanding that they will not be used to interpret or limit the scope or meaning of the claims. They are provided to introduce a selection of concepts in simplified form that are further described in the Detailed Description. The Title, Field, and Background are not intended to identify key features or essential features of the claimed subject matter, nor is it intended to be used as an aid in determining the claimed subject matter.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the disclosure are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the disclosure by way of example and not by way of limitation. This description enables one skilled in the art to make and use the aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure is not limited in its application to the details of construction and the arrangement of components set forth in the description or illustrated in the drawings. The aspects of the disclosure are capable of other embodiments and of being practiced or carried out in various ways. Also, it will be understood that the phraseology and terminology used herein is for the purpose of description and should not be regarded as limiting.

Having described aspects of the disclosure in detail, it will be apparent that modifications and variations are possible without departing from the scope of aspects of the disclosure as defined in the appended claims. It is contemplated that various changes could be made in the above constructions, products, and methods without departing from the scope of aspects of the disclosure. In the preceding specification, various embodiments have been described with reference to the accompanying drawings. It will, however, be evident that various modifications and changes may be made thereto, and additional embodiments may be implemented, without departing from the broader scope of the aspects of the disclosure as set forth in the claims that follow. The specification and drawings are accordingly to be regarded in an illustrative rather than restrictive sense.

What is claimed is:

1. A container processing system for a container, the container processing system comprising:
a conveyor configured to transport the container toward a set location;
a container positioner configured to position the container in the set location;
a first container sensor arranged to detect a height of the container when the container is in the set location;
a second container sensor arranged to detect a length of the container when the container is in the set location; and
a third container sensor arranged to detect a width of the container when the container is in the set location.

2. The container processing system of claim 1, further comprising a container position sensor arranged to detect whether or not the container is in the set location.

3. The container processing system of claim 1, wherein the conveyor is arranged to support the container when the container is in the set location.

4. The container processing system of claim 3, further comprising a first guide and a second guide, the first and second guides defining the set location.

5. The container processing system of claim 4, wherein the first and second guides extend generally perpendicularly relative to one another.

6. The container processing system of claim 1, further comprising a container transporter, the container transporter configured to remove the container from the set location.

7. The container processing system of claim 6, further comprising a labeler, the labeler configured to supply a label for the container, the container transporter configured to move the container to the labeler to have the label applied to the container.

8. The container processing system of claim 7, further comprising a first scanner, the container transporter configured to move the container to a first scanning location, the first scanner being arranged to scan a machine-readable code of the container when the container is at the first scanning location.

9. The container processing system of claim 8, further comprising a second scanner, the container transporter configured to move the container to a second scanning location, the second scanner being arranged to scan a machine-readable code of the label applied to the container when the container is at the second scanning location.

10. A method of processing a container, the method comprising:
positioning the container in a set location;
determining at least one dimension of the container when the container is in the set location;
validating the container by comparing the at least one dimension of the container with at least one reference dimension; and
removing the container from the set location after said validating.

11. The method of claim 10, wherein said determining the at least one dimension of the container includes determining a height of the container, a length of the container, and a width of the container.

12. The method of claim 11, wherein the at least one reference dimension includes a reference height, a reference length, and a reference width, and wherein said comparing the at least one dimension of the container with at least one reference dimension includes comparing the height of the container with the reference height, comparing the length of the container with the reference length, and comparing the width of the container with the reference width.

13. The method of claim 10, further comprising:
positioning the container relative to a first scanner based on the at least one reference dimension; and
validating the container again by scanning a machine readable code of the container with the first scanner.

14. The method of claim 13, further comprising:
positioning the container relative to a label based on the at least one reference dimension; and
applying the label to the container after said positioning the container relative to the label.

15. The method of claim 14, further comprising:
positioning the container relative to a second scanner based on the at least one reference dimension; and
validating the label applied to the container by scanning a machine readable code of the label with the second scanner.

16. The method of claim 10, further comprising, prior to said positioning the container at the set up location:
positioning a sample container in the set location;
determining at least one dimension of the sample container when the sample container is in the set location; and
setting the at least one dimension of the sample container as the at least one reference dimension.

17. The method of claim 16, wherein the at least one reference dimension includes a reference height, a reference length, and a reference width, wherein said determining at least one dimension of the sample container includes determining a height of the sample container, a length of the sample container, and a width of the sample container, and wherein said setting the at least one dimension of the sample container as the at least one reference dimension includes setting the height of the sample container as the reference height, the length of the sample container as the reference length, and the width of the sample container as the reference width.

18. The method of claim 17, where said comparing the at least one dimension of the container with at least one reference dimension includes comparing the height of the container with the reference height, comparing the length of the container with the reference length, and comparing the width of the container with the reference width.

19. The method of claim 16, further comprising orienting the sample container relative to a first scanner until a desired machine readable code of the sample container is facing the first scanner and setting the orientation that the sample container is in relative to the first scanner when the desired machine readable code of the sample container is facing the first scanner as a first scanning orientation, and
the method further comprising, during said processing of the container:
positioning the container relative to the first scanner based on the at least one reference dimension and orienting the container in the first scanning orientation to present a machine readable code of the container to the first scanner; and
validating the container again by scanning the machine readable code of the container with the first scanner.

20. The method of claim 16, further comprising orienting the sample container relative to a labeler until a label from the labeler will be applied at a desired label location on the sample container and setting the orientation that the sample container is in relative to the labeler when the label will be applied at the desired label location as a label orientation, and
the method further comprising, during said processing of the container:
positioning the container relative to a label based on the at least one reference dimension and orienting the container in the label orientation; and
applying the label to the container after said positioning and orienting the container relative to the label.
